(19) United States
(12) Patent Application Publication
(10) Pub. No.: US 2008/0025038 A1
(43) Pub. Date: Jan. 31, 2008

(54) Thermal module system for LED headlamp module

(75) Inventor: Song-Bor Chiang, Chu-Tung (TW)

Correspondence Address: BIRCH STEWART KOLASCH & BIRCH, PO BOX 747, FALLS CHURCH, VA, 22040-0747, US

(73) Assignee: Industrial Technology Research Institute

(21) Appl. No.: 11/644,945

(22) Filed: Dec. 26, 2006

(30) Foreign Application Priority Data
Jul. 25, 2006 (TW) 95127155

(51) Int. Cl. B60Q 1/04; F21V 29/02

(52) U.S. Cl. 362/547; 362/373

(57) ABSTRACT

A thermal module system for LED headlamp module includes a LED module, heat produced by which is transmitted via a heat conductive element to a heat sink module and dissipated. The heat sink module is arranged in an air passage in a car, such as behind a front bumper, at an inner side of the front fender of said car, or in front of the radiator. Heat insulating material is provided around the LED module to prevent high temperature of an engine compartment from being transmitted to the LED module. The air passage has vents provided on the front bumper and the front fender of said car, so that the heat sink module has enhanced thermal performance due to natural or forced air convection. A fan or water sprayer may be provided near the heat sink module to improve the thermal performance. Therefore, the LED module may work at a lowered ambient air temperature to have a prolonged lifetime.

### FIELD OF THE INVENTION

The present invention relates to a thermal module system for light emitting diode (LED) headlamp, and more particularly to a thermal module system for LED headlamp module is capable of lowering ambient air temperature in which a LED headlamp works by isolating the LED headlamp from heat produced in an engine compartment of a car, so that the LED headlamp has a prolonged lifetime.

### BACKGROUND OF THE INVENTION

The light emitting diode (LED) was first introduced into the world in 1968, and featured by many advantages, including energy-saving, lightweight, long lifetime, low driving voltage, rapid response time, and outstanding shockproof ability. In the seventies of twenty century, the LED was commercialized and most researches thereof were directed to high brightness, multi-color, and high light efficiency. Thereafter, in the eighties, high-brightness GaAsP LED(red) and GaP LED(green) were successively developed. In the nineties, there were also successively developed high-brightness four-element AlGaInP red and orange LEDs, and InGaN blue and green LEDs. Ultraviolet LEDs has also been developed in recent years. With the constantly increased unit brightness of the LEDs, LEDs have been more and more widely applied in different fields from small indicators on electronic apparatus to large-size outdoor signboards. In the rear half of the 1990s, LEDs were first used on traffic signals and gradually replaced incandescent bulbs. The LED saves more than 80% of electric energy, compared to the incandescent bulb. The successful development of blue LED also stimulates the rapid development of white LED. Meanwhile, with the increasingly improved LED manufacturing techniques and the constantly enhanced brightness, the white LED very possibly becomes a light source for cars. The advantages of lightweight and compactness of the LED particularly make the car light design simpler and more convenient, and allow the car lighting fixture to have longer lifetime and be energy-saving.

While the LED has good potential in the field of car headlamp, there are still many technical necks to be overcome. The first and most important one of these technical necks in the application of LED in car headlamp is the temperature factor. For a LED, the light intensity is generally in direct proportion to the driving current thereof. However, the increase of temperature also changes the lighting property and shortens the lifetime of LED. The lighting property of the LED tends to be affected by ambient air temperature. When the ambient air temperature rises, the LED shall have a reduced light output. Therefore, ambient air temperature is a major factor determining the light output and lifetime of the LED, and also a main obstacle in the application of LED in car headlamp. This is mainly because most existing car headlamps are produced using a lightweight material, and have a low profile to reduce an overall thickness thereof, resulting in a largely reduced space for mounting the headlamp. Heat is produced by the working LED headlamp accumulated in the small mounting space could not be conducted to an external environment. Moreover, the headlamp is located in the car engine compartment. Heat produced by the LED together with the great amount of heat from the engine compartment adversely lower the efficiency and lifetime of the LED headlamp.

Conventional thermal modules for cooling are designed simply to convect the heat produced by electronic components to air. With the development of multi-functional electronic products, heat produced by the electronic products rapidly increases. Among various kinds of electronic products for car being developed in all countries in the world, LED headlamp is most difficult to design due to the thermal problem thereof. The headlamp is located in the engine compartment, which is a high-temperature area often higher than 80° C. An area near a radiator in the engine compartment even has a temperature higher than 100° C. Therefore, it is necessary to develop a thermal module system to effectively dissipate heat produced by the LED headlamp and to reduce the adverse influence of high-temperature engine compartment on the LED headlamp, so as to extend the lifetime of the LED headlamp.

### SUMMARY OF THE INVENTION

A primary object of the present invention is to provide a thermal module system which is independently located distant from heat-producing elements in a car engine compartment, and lowers the ambient air temperature of the LED headlamp by isolating the heat is produced by the engine compartment from the LED headlamp, so as to extend the lifetime of the LED headlamp.

To achieve the above and other objects, the thermal module system for LED headlamp module according to the present invention includes a thermal module arranged on the car in an air passage, which is distant from heat-producing elements in the engine compartment and has a temperature relatively lower than that of the engine compartment, such as in or behind a front bumper, at an inner side of a front fender of said car, or at a radiator side; a LED module for forming the LED headlamp; and a heat conductive element connected at an end to the heat sink module and at the other end to the LED module to transmit heat produced by the LED module to the heat sink module. Preferably, a heat insulating material is provided around the LED module to supply a space isolated the heat from the engine compartment and thereby reduces the heat being transmitted from the engine compartment and other high-temperature elements to the LED module. That is, the LED module is isolated from heat produced by the engine compartment, while the heat produced by the LED module is transmitted via the heat conductive element to the heat sink module and then dissipated. The air passage has vents provided on the front bumper, the front fender of said car, and/or a clearance around the front fender of said car. The heat insulating material may also be provided around the air passage to further isolate the air passage from heat sources. Since the thermal module is arranged in the air passage, its heat dissipating capacity is enhanced by natural convection of airflow passed through the air passage when the car is in the idle or still state, or by forced convection of air flow passed through the air passage when the car is in the running or moving state. A fan may also be provided near the heat sink module to actively enhance the convection effect. Further, a water sprayer may be provided in the car near the heat sink module to enhance the thermal performance of the thermal module system. With these arrangements, the LED module may work at a lowered ambient air temperature to prolong its lifetime.

The thermal module system of the present invention has simple structure to enable manufacture at reduced cost. Since the thermal module system for LED headlamp module of the present invention is independently provided in the car, it does not involve in linking or connection to other components. So, the car is easy to facilitate convenient assembly thereof and future maintenance or repair.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein

FIG. 1 is a front view of a thermal module system for LED headlamp module according to the present invention;

FIG. 2 is a side view of the thermal module system for LED headlamp module of FIG. 1;

FIG. 3 is a front view of a thermal module system for LED headlamp module according to a first embodiment of the present invention;

FIG. 4 is a side view of FIG. 3;

FIG. 5 is a top view a thermal module system for LED headlamp module according to a second embodiment of the present invention;

FIG. 6 is a front view of a thermal module system for LED headlamp module according to a third embodiment of the present invention;

FIG. 7 is a top view of FIG. 6; and

FIG. 8 is a fragmentary enlarged view schematically shows a thermal module system for LED headlamp module of the present invention equipped with a water sprayer.

### DETAILED DESCRIPTION OF THE PREFERRED EMBODIMENTS

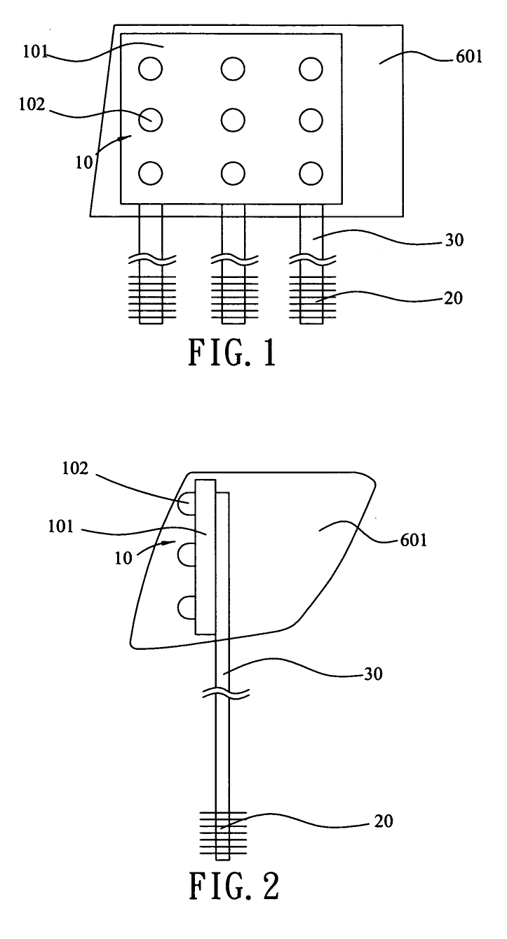

Please refer to FIGS. 1 and 2 that are front and side views, respectively, of a thermal module system for LED headlamp module according to the present invention. As shown, the thermal module system for LED headlamp module of the present invention includes a LED module 10, at least one heat sink module 20, and at least one heat conductive element 30.

The LED module 10 is mounted inside a headlamp 601 of a car 60 (not shown in FIGS. 1 and 2), and includes a panel 101 and a plurality of light emitting diodes (LEDs) 102 mounted on the panel 101. When the current is supplied from the car 60 to the LED module 10, the light emitting diode 102 on the panel 101 emit light, which is projected from the headlamp 601 by a reflector in the headlamp 601.

The heat sink module 20 is arranged in an air passage 50 in the car 60, and is made of a high thermal conductivity material, such as aluminum, copper, etc. The heat sink module 20 is provided with a plurality of fins, which may be stacked fins, tunnel-type fins, thinned fins, extruded aluminum fins and so on. In the case of the tunnel-type fins, airflow may pass through the fins to enhance the convection heat transfer coefficient of the fins, and accordingly, to increase the thermal performance of the whole heat sink module 20.

The heat conductive element 30 is connected at two ends to the LED module 10 and the heat sink module 20. It conducts heat produced by the LED module 10 to the heat sink module 20. Preferably, the heat conductive element 30 is a heat pipe.

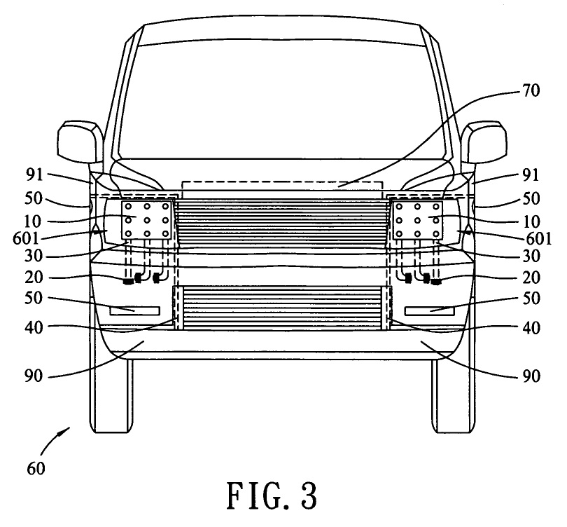

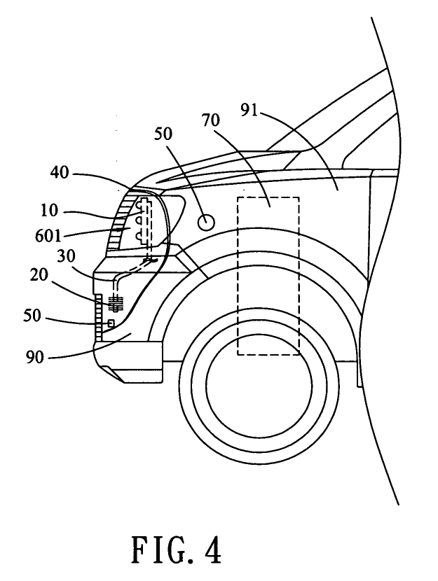

Please refer to FIGS. 3 and 4 that are front and side views, respectively, of a thermal module system for LED headlamp module according to a first embodiment of the present invention. As shown, the thermal module system for LED headlamp module is mounted in a car 60. The car 60 is provided at left and right front ends with a headlamp 601 each, and below the headlamps 601 with a front bumper 90. An engine 70 is provided in an engine compartment of the car 60.

In the first embodiment, the heat sink module 20 is arranged on the car 60 in an air passage 50, and the airflow pass through the heat sink module 20. The air passage 50 is preferably located at an inner side of or behind the front bumper 90. Since a space behind the front bumper 90 is distant from a radiator 80 (not shown in FIGS. 3 and 4), an exhaust manifold, and the engine 70, and has a relatively lower ambient air temperature. The heat sink module 20 may be adequately arranged in this space to dissipate heat. Further, there is a clearance between the car frame and a front fender 91 of said car 60 at each lateral side of the car 60 or the front bumper 90. The heat sink module 20 may also be arranged near the clearance to successfully dissipate heat conducted thereto.

An insulating material 40 may be further provided around the LED module 10 to produce a space isolated the heat from the high temperature of the engine compartment, so as to minimize the heat being conducted or convected from the engine compartment and other high-temperature elements thereof to the LED module 10. That is, the LED module 10 isolated from the heat of the engine compartment, and the heat produced by LED module is conducted via the heat conductive element 30 to the heat sink module 20 and dissipated the heat to air.

Preferably, an opening is formed on the front bumper 90 to serve as a vent of the air passage 50. The insulating material 40 may also be provided around the air passage 50 to provide an enhanced heat insulating effect. As having been mentioned above, the heat sink module 20 is arranged in the air passage 50. An opening is also formed on the front fender 91 of said car 60 or the gap between the car shape and the fender to form another vent of the air passage 50. When the car 60 is moving, airflow passes into and out of the air passage 50 via the vents on the front bumper 90 and the front fender 91 of said car 60, respectively, to enhance the thermal performance of the heat sink module 20. When the car 60 is in the idle or still state, the insulating material 40 provided around the headlamp 601 and the air passage 50 isolates the LED module 10 and the heat sink module 20 from the heat transmitted by airflow produced by the fan of the radiator 80, and from the heat produced by other heat-producing elements. That is, either the car 60 is in the still state or in the moving state, airflow may always flow into and out of the air passage 50 due to natural or forced convection of air to enhance the thermal performance of the heat sink module 20. In other words, by taking advantage of the lower ambient air temperature and a ram-air effect, the heat sink module 20 may have improved thermal performance through natural and forced air convection. Therefore, the heat sink module 20 located in or behind the front bumper 90 of the car 60, the heat conductive element 30, the insulating material 40, and the air passage 50 together form an independent thermal module system to isolate the heat sink module 20 from the heat produced in the engine compartment, so that the ambient air temperature of the LED module 10 in use is reduced to prolong the usable lifetime of the LED module 10. Further, a fan or blower(not shown) may be provided in the vicinity of the heat sink module 20 to actively increase the thermal performance of the heat sink module 20 and enhance the convection heat transfer coefficient of it.

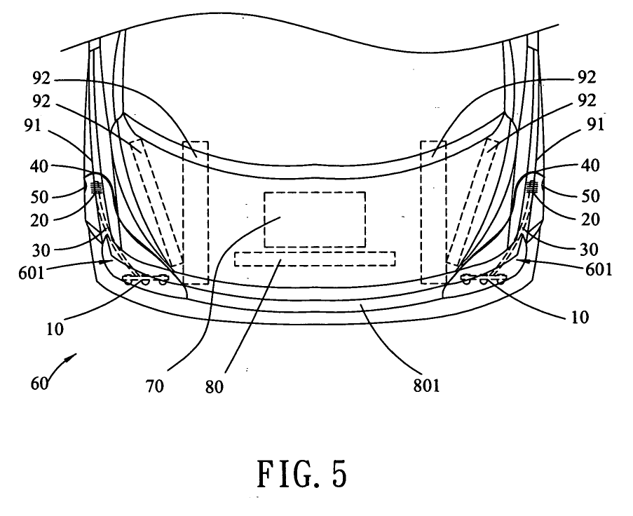

FIG. 5 is a top view of a thermal module system for LED headlamp module according to a second embodiment of the present invention. As shown, the thermal module system for LED headlamp module is mounted in a car 60. The car 60 is provided at left and right front ends with a headlamp 601 each. A front fender 91 of said car 60 rearward extends from the headlamp 601. An engine 70 is provided in an engine compartment of the car 60. Since the engine 70 and the front fender 91 of said car 60 are separated from each other by the frame 92 of the car 60, a space near an inner side of the front fender 91 of said car 60 has a temperature relatively lower than that in the engine compartment. In the second embodiment of the present invention, the heat sink module 20 is arranged in the space between the frame 92 and the front fender 91 of said car 60, and heat produced by the LED module 10 is conducted via the heat conductive element 30 to the heat sink module 20 and dissipated.

To further stop heat produced by the engine compartment and other high-temperature elements from transmitting to the LED module 10, it is preferably to provide a heat isolating material 40 around the LED module 10 to supply a space isolated from the high-temperature engine compartment, and heat produced by the LED module 10 is conducted via the heat conductive element 30 to the heat sink module 20 and dissipated. An air passage 50 in the car 60 has two vents formed on the front fender 91 of said car 60. Airflow goes into and flows out of the air passage 50 via the two vents. Preferably, the two vents of the air passage 50 are separately located near a front and a rear end of the front fender 91 of said car 60. The insulating material 40 may also be provided around the air passage 50, and the heat sink module 20 is arranged in the air passage 50. When the car 60 is in the still state or in the moving state, airflow may always flow into and out of the air passage 50 due to natural or forced air convection, respectively, enabling the heat sink module 20 to have an enhanced thermal performance and improved convection heat transfer coefficient. A fan (not shown) may be provided in the vicinity of the heat sink module 20 to actively increase the thermal performance of the heat sink module 20 and enhance the convection effect.

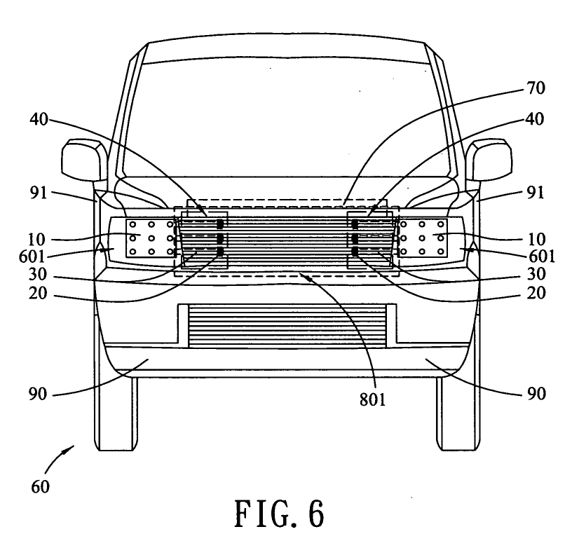

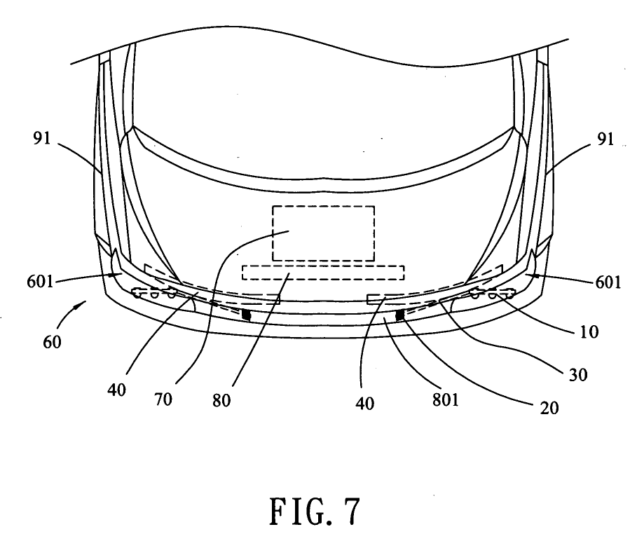

Please refer to FIGS. 6 and 7 that are front and top views, respectively, of a thermal module system for LED headlamp module according to a third embodiment of the present invention. As shown, the thermal module system for LED headlamp module is mounted in a car 60. The car 60 is provided at left and right front ends with a headlamp 601 each. An engine 70 and a radiator 80 are provided in an engine compartment of the car 60. A grille 801 is provided in front of the radiator 80. In the third embodiment of the present invention, the heat sink module 20 is located in the car 60 at the radiator 80 side. That is, the heat sink module 20 is arranged in a space between the radiator 80 and the grille 801. The space between the radiator 80 and the grille 801 is quite distant from the engine 70 and other heat-producing elements and accordingly a relatively low ambient air temperature, and is therefore suitable for receiving the heat sink module 20 therein to dissipate heat.

Preferably, a heat insulating material 40 is provided around the LED module 10 to supply a space isolated from the high-temperature engine compartment. It is more preferable to provide the heat insulating material 40 between the heat sink module 20 and the radiator 80, so as to prevent the high temperature of the radiator 80 from dropping off the thermal performance of the heat sink module 20, and reduce the heat that is produced by the engine compartment and other high-temperature elements and transmitted to the LED module 10. When the car 60 is in the moving state, airflow flows into the car via the grille 801 in front of the radiator 80 to form a forced convection in the engine compartment and enhance the thermal performance of the heat sink module 20 arranged between the grille 801 and the radiator 80. When the car 60 is in the idle or still state, heat may still be dissipated due to natural convection. A fan or blower (not shown) may be provided in the vicinity of the heat sink module 20 to actively improve the thermal performance of the heat sink module 20 and enhance the convection effect. In this embodiment, the grille 801 serves as an inlet of an air passage 50 for airflow to pass therethrough.

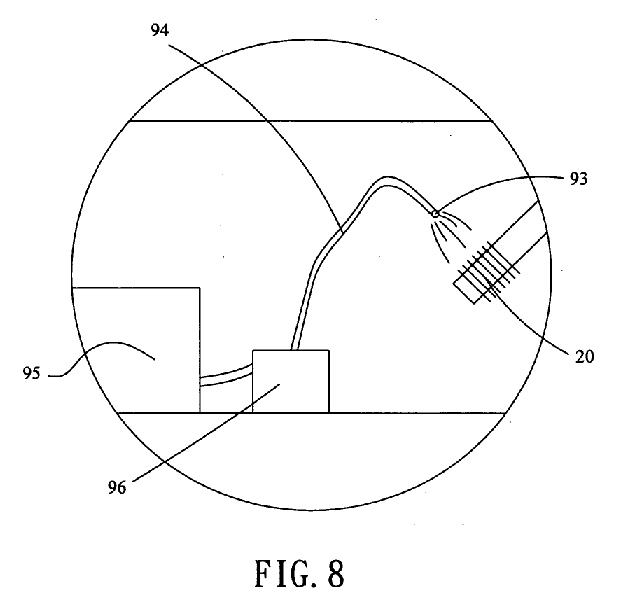

FIG. 8 is a fragmentary enlarged view schematically shows a thermal module system for LED headlamp module of the present invention equipped with a water sprayer. As mentioned above, the heat sink module 20 is arranged in an air passage 50 in the car 60. A water sprayer 93 may be further provided in the vicinity of the heat sink module 20, so that water may be sprayed to outer surfaces of the fins on the heat sink module 20 to increase the thermal performance. The water sprayer 93 is connected to a pump 96 via a water pipe 94, and the pump 96 is connected to a water reservoir 95 built in the car 60 via another water pipe 94. Alternatively, the water reservoir 95 may be separately provided. Therefore, water stored in the water reservoir 95 may be pumped by the pump 96 and passed via the water pipe 94 to the sprayer 93, and finally sprayed onto the heat sink module 20 to enhance the convection effect of the heat sink module 20.

In summary, in the thermal module system for LED headlamp module according to the present invention, a heat sink module is arranged on a car in an air passage having air flowing therethrough, such as a space in or behind the front bumper, at an inner side of the front fender of said car, or at the radiator side. Heat produced by the LED headlamp module is conducted by a heat conductive element to the heat sink module and dissipated. Since the heat sink module is arranged in the air passage, its thermal performance may be enhanced through either natural or forced air convection. A fan may be provided near the heat sink module to further improve the thermal performance. A water sprayer may also be provided in the car near the heat sink module to enhance the thermal performance using water spray. With these arrangements, the LED headlamp module may work at a lowered ambient air temperature to thereby have a prolonged lifetime.

What is claimed is:

1. A thermal module system for LED headlamp module, comprising:
a LED module mounted in a headlamp of a car;
at least one heat sink module having a plurality of fins, said heat sink module being arranged on the car in an air passage, through which airflow passes; and
at least one heat conductive element being connected at two ends to said LED module and said heat sink module, so that heat produced by said LED module is transmitted via said heat conductive element to said heat sink module.

2. The thermal module system for LED headlamp module as claimed in claim 1, wherein said LED module includes a panel and a plurality of light emitting diodes (LEDs) mounted on said panel.

3. The thermal module system for LED headlamp module as claimed in claim 1, wherein said air passage is located behind a front bumper of said car.

4. The thermal module system for LED headlamp module as claimed in claim 3, wherein said air passage has a vent provided on said front bumper.

5. The thermal module system for LED headlamp module as claimed in claim 1, wherein said air passage is located at an inner side of the front fender of said car.

6. The thermal module system for LED headlamp module as claimed in claim 5, wherein said air passage has a vent provided on said front fender of said car.

7. The thermal module system for LED headlamp module as claimed in claim 1, wherein said air passage is located at a radiator side of said car.

8. The thermal module system for LED headlamp module as claimed in claim 1, further comprising a heat insulating material provided around said LED module and said heat sink module, such that said LED module and said heat sink module are isolated from a high-temperature engine compartment of said car while heat produced by said LED module is dissipated via said heat sink module.

9. The thermal module system for LED headlamp module as claimed in claim 8, wherein said insulating material is also provided around said air passage.

10. The thermal module system for LED headlamp module as claimed in claim 1, further comprising a fan located in the vicinity of said heat sink module to enhance the thermal performance of said heat sink module.

11. The thermal module system for LED headlamp module as claimed in claim 1, wherein said heat conductive element is a heat pipe.

12. The thermal module system for LED headlamp module as claimed in claim 1, further comprising a water sprayer, water pipes, a water reservoir, and a pump; said water sprayer being connected to said pump via one of said water pipes, and said water reservoir being connected to said pump via another said water pipe.

13. The thermal module system for LED headlamp module as claimed in claim 12, wherein said water reservoir is built in said car.

14. The thermal module system for LED headlamp module as claimed in claim 1, wherein said plurality of fins are selected from the group consisting of stacked fins, tunnel-type fins, thinned fins, and extruded aluminum fins.

15. The thermal module system for LED headlamp module as claimed in claim 5, wherein said air passage utilizes a gap on said car around said front fender of said car as a vent.
